(19) United States
(12) Patent Application Publication
(10) Pub. No.: US 2002/0112579 A1
(43) Pub. Date: Aug. 22, 2002

(54) Method and device for cutting continuously conveyed, flat objects

(76) Inventor: Erich Jager, Frauenfeld (CH)

Correspondence Address: OPPEDAHL AND LARSON LLP, P O BOX 5068, DILLON, CO, 80435-5068, US

(21) Appl. No.: 09/954,337

(22) Filed: Sep. 10, 2001

Related U.S. Application Data
(63) Continuation of application No. 09/341,601, filed on Sep. 17, 1999, now abandoned.

(51) Int. Cl. B26D 1/56

(52) U.S. Cl. 83/37; 83/349; 83/607

(57) ABSTRACT

The described method serves for trimming or cutting during conveyance in a conveying direction (F) substantially in parallel to their main surfaces, flat objects along predetermined cutting lines parallel to the conveying direction (F). The objects are conveyed between a first and a second cutting edge (SK₁ and SK₂) and are cut by a relative movement of the two cutting edges. The first cutting edge (SK₁) is positioned, e.g. stationary, in the plane of a support surface supporting the objects and for each cutting process, the second cutting edge (SK₂) is moved past the first cutting edge in such a manner that at least the cutting point on the second cutting edge has a speed component in conveying direction (F) which has the same size as the conveying direction and a speed component perpendicular to the support surface. This is advantageously realized by a swiveling or rotating movement of the second cutting edge (SK₂) around a rotation axis (M) arranged above the support surface, whereby for fulfilling the above condition, the distance (y) of the rotation axis from the support surface and the rotation speed (ω) are correspondingly matched. Advantageously, a plurality of second cutting edges (SK₂) are arranged in a star-shaped manner in a plane perpendicular to the rotation axis (M) and the arrangement of second cutting edges (SK₂) is rotated around the rotation axis at a constant speed (ω).

The invention concerns a method according to the generic term of the first independent claim. The method serves for cutting along predetermined cutting lines, flat objects being conveyed continuously and in parallel to their main surfaces whereby the cutting lines are parallel to the conveying direction. The method is particularly suitable for cutting flat objects which are difficult to be cut because they are e.g. easily deformable and/or consist of several possibly easily deformable layers which layers adhere to each other only slightly. Multi-page printed products made of relatively thin paper are an example for this kind of flat objects.

The invention further concerns a device according to the generic term of the corresponding independent claim for carrying out the method.

Flat objects are normally cut or trimmed in a direction perpendicular to their main surfaces. They are e.g. positioned between two straight cutting edges being positioned in a plane perpendicular to the main surfaces and being moved past each other and crossing each other such that the crossing point of the two cutting edges in which point cutting actually takes place moves along the predetermined cutting line across the main surfaces of the object to be cut. Hereby, one of the two cutting edges may lie in the plane of a surface supporting the object to be cut or be a part of this supporting surface. The other cutting edge is then moved relative to the supporting surface, either by being swiveled about an axis or in a movement perpendicular to the supporting surface. Thereby, the one cutting edge moving relative to the support surface is oriented at an angle to the support surface (cutting angle). This kind of cutting method is called cross cutting and is best known as shearing cut of stationary objects.

Devices for cross cutting flat objects being continuously conveyed perpendicular to their main surfaces are e.g. known from the publication EP-367715, devices for cutting flat objects being conveyed in parallel to their main surfaces e.g. from the publication U.S. Pat. No. 3,069,952 or from the publication EP-0698451. If cutting lines of objects being conveyed in parallel to the their main surfaces are perpendicular to the conveying direction the two cutting edges are arranged perpendicular to the conveying direction also. For such a cutting process, a finite time is needed and therefore, for achieving a high cutting precision it is obviously necessary to move the cutting device, at least during the cutting process, together with the object to be cut.

It shows that for cutting lines parallel to the conveying direction and conveyance in parallel to the main surfaces of the objects to be cut, a relative movement of the object to be cut and the cutting edges parallel to the conveying direction and friction forces created by such movement can have a negative effect on the cutting quality. This negative effect can be suppressed by pressing the objects to be cut against a support surface, at least during the cutting process. Such pressing e.g. prevents the object to be cut from being deformed by the relative movement and friction forces or if it consists of layers hardly adhering to each other the pressing prevents these layers from being shifted relative to each other and from such rendering the cut inaccurate.

According to publication EP-0698451, the attempt is made to prevent the above described relative movements between a continuously conveyed object and the cutting edges by moving at least one cutting edge together with the object to be cut in conveying direction. For cutting parallel to the conveying direction, flat objects conveyed in parallel to their main surfaces, this publication suggests to use two cutting blades with straight cutting edges facing each other and to move at least one of these blades with the help of two cranks, whereby a part of the thus created cyclic blade movement is exploited as cutting travel (perpendicular to the conveying direction) and as conveying travel (in conveying direction).

In the same publication it is postulated that the cutting quality achievable with the cutting device as described is best when the speed of the blade conveying travel is approximately the same as the conveying speed of the object to be cut, i.e. when during cutting, relative movements in conveying direction are prevented as far as possible. However, because of the conveying travel being created by the cranks changes sine-like the above condition can, if at all, only be fulfilled during a very short time. Therefore, either the cutting process must be restricted to a correspondingly short time, i.e. the cutting angle (angle between the two cutting edges involved in the cutting process) must be made very small, or a larger relative movement between the cutting edge and the object to be cut must be accepted, both of which facts restrict the application of the described device.

It is the object of the invention to create a method for cutting between two blades and along predetermined cutting lines, flat objects conveyed continuously and at a constant conveying speed substantially in parallel to their main surfaces, whereby a first cutting edge lies in the plane of a support or conveying surface of an object to be cut and the second cutting edge is moved past the first cutting edge and advantageously crosses it. The inventive cutting method is to enable sufficient to very high cutting qualities at low pressing forces by suitable guidance of at least the second cutting edge. In particular, the inventive cutting method is to make it possible to cut accurately and with a satisfying cutting quality objects which are difficult to be cut (e.g. objects which are easily deformable and/or consist of layers which adhere only slightly to each other) without the necessity of high pressing forces as needed in methods according to the state of the art and possibly having a negative effect on sensitive objects. All the same the cutting parameters, especially the cutting angle and the cutting speed are to be freely choosable within wide ranges, i.e. the method is to be simply adaptable to the most various applications.

Furthermore, it is the object of the invention to create a device for carrying out the method which device can be realized and operated with the most simple means.

This object is achieved by the method and the device as defined in the claims.

The invention bases on the finding that it is possible to cut printed products consisting of a plurality of pages with satisfying to very high cutting quality although pressed onto a support surface with very slight pressure only or even without pressure, if in every moment of the cutting process at least the one point of the second cutting edge, which is involved in the cutting process (crossing point with the first cutting edge or cutting point), has a speed relative to the object to be cut which is directed as precisely perpendicular as possible to the support surface or to the first cutting edge or towards the main surfaces of the object to be cut respectively. This means that it is sufficient for only this cutting point of the second cutting edge to have an absolute speed having a component in conveying direction as precisely identical to the conveying speed as possible.

According to the inventive method, at least the second cutting edge which is moved towards the support surface is moved in a manner matched to the continuos conveying of the objects to be cut such that in each moment of the cutting process, at least the cutting point of this cutting edge has a speed of which the component in conveying direction is of the same size as the constant conveying speed. Due to this the friction forces in conveying direction mentioned further above, which friction forces have an accelerating or decelerating or in any case a destabilizing effect on the printed products to be cut, are prevented such that their effect does not have to be counteracted by pressing.

For the purpose of generalization it is stated that for the case in which the first cutting edge is arranged in the plane of the support surface as is suggested in the preceding paragraphs the products to be cut lie against this support surface and against the first speed identical to the conveying speed. In such a case, again in every moment of the cutting process, not only the cutting point on the second cutting edge but the whole cutting edge has a speed relative to the object to be cut which is orientated precisely perpendicular to the support surface.

It shows that in many applications it is sufficient for the first cutting edge arranged in the plane of the support surface of the objects to be cut to be stationary. However, this cutting edge may be moved also such that there is as little relative movement as possible between the first cutting edge and the objects to be cut.

The inventive method and different, exemplified embodiments of the device for carrying out the method are described in more detail in connection with the following Figures, whereby

FIG. 1 shows the principle of a preferred embodiment of the inventive method;

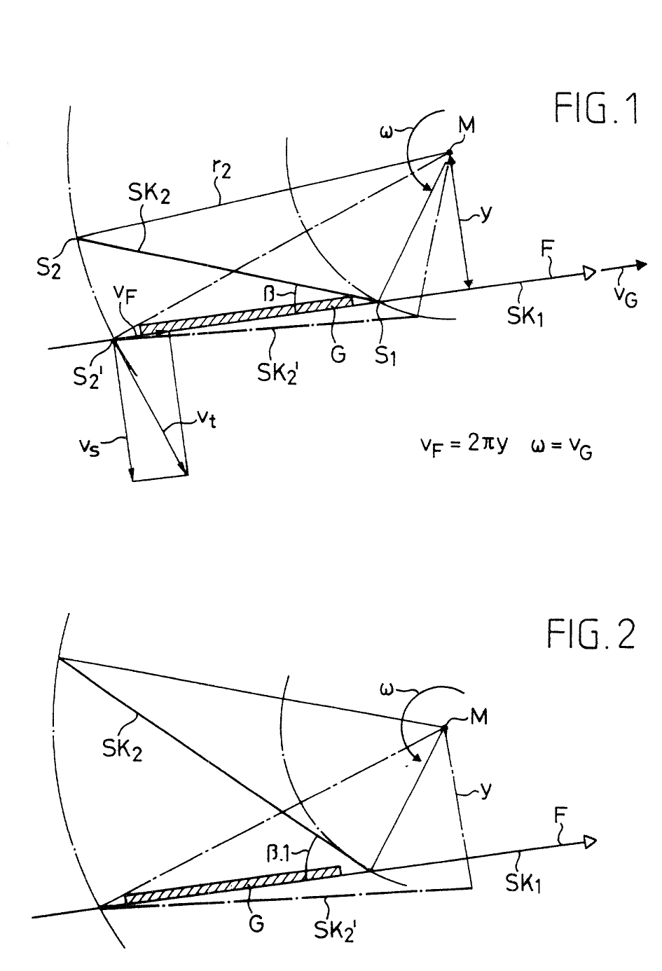

FIGS. 2 to 5 are further representations like FIG. 1 illustrating various cutting angles.

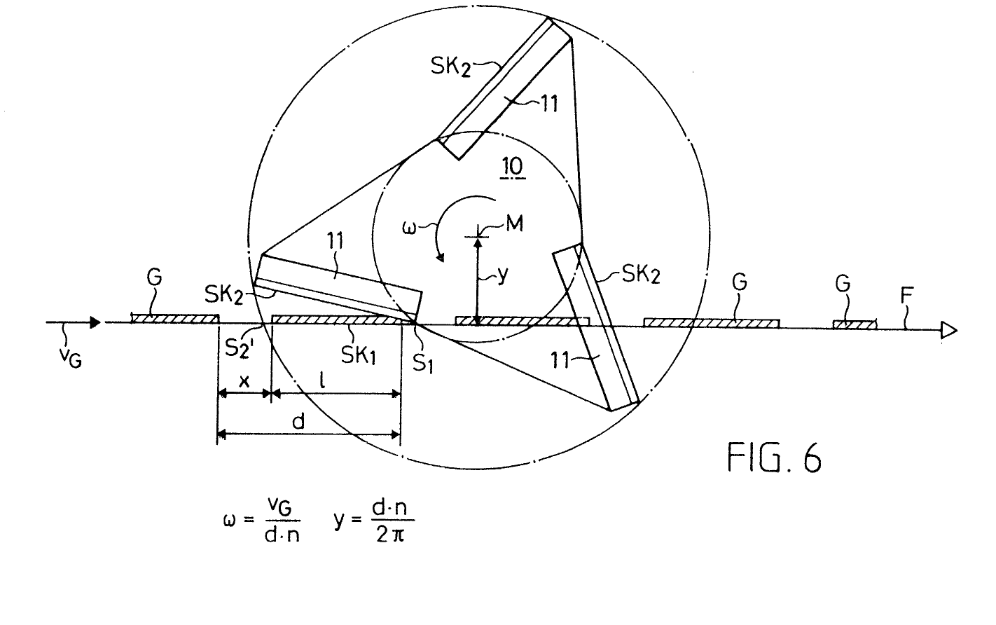

FIGS. 6 and 7 show two exemplified embodiments of the inventive device with rotating second cutting edges;

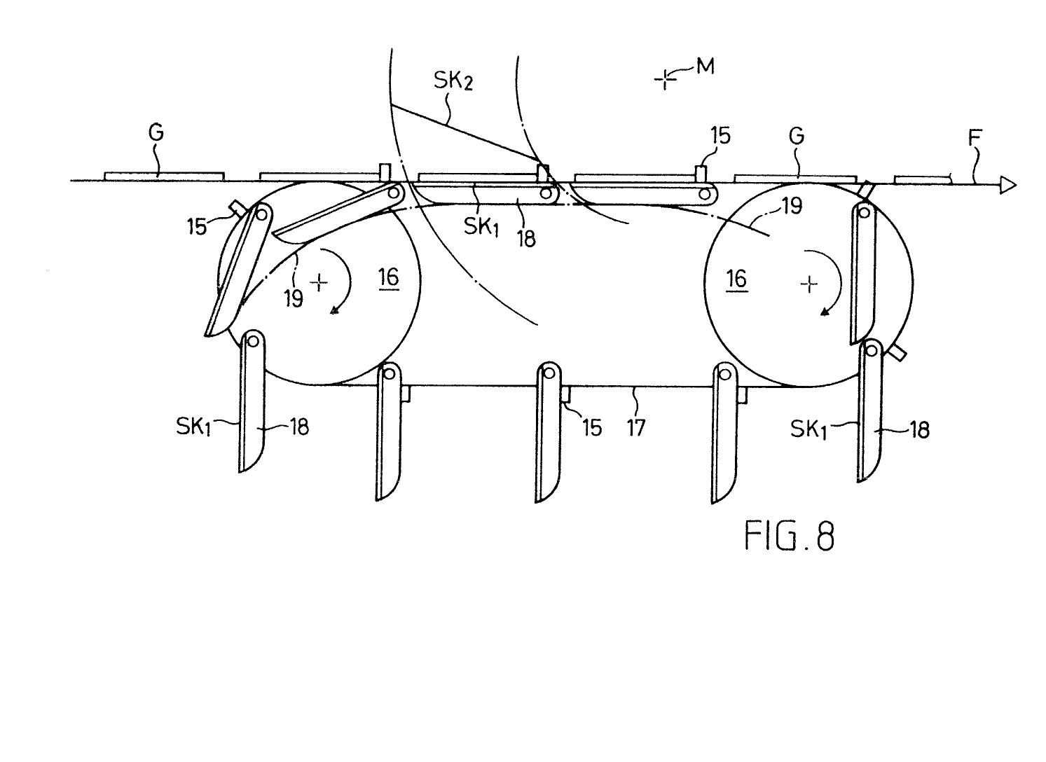

FIG. 8 shows an exemplified embodiment of the inventive device equipped for simultaneous movement of the first cutting edge;

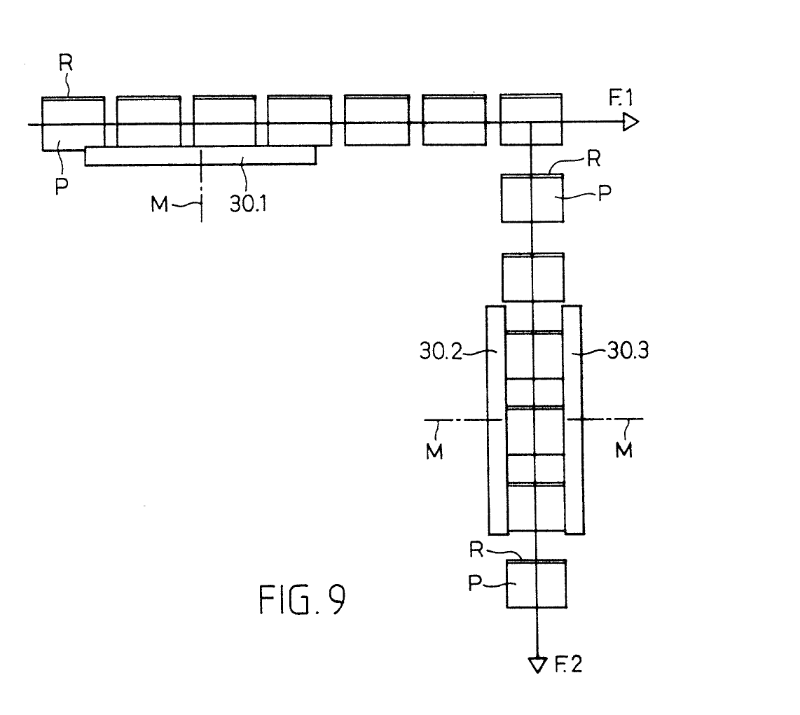

FIG. 9 shows an arrangement with three inventive devices for three-sided trimming of printed products e.g. magazines;

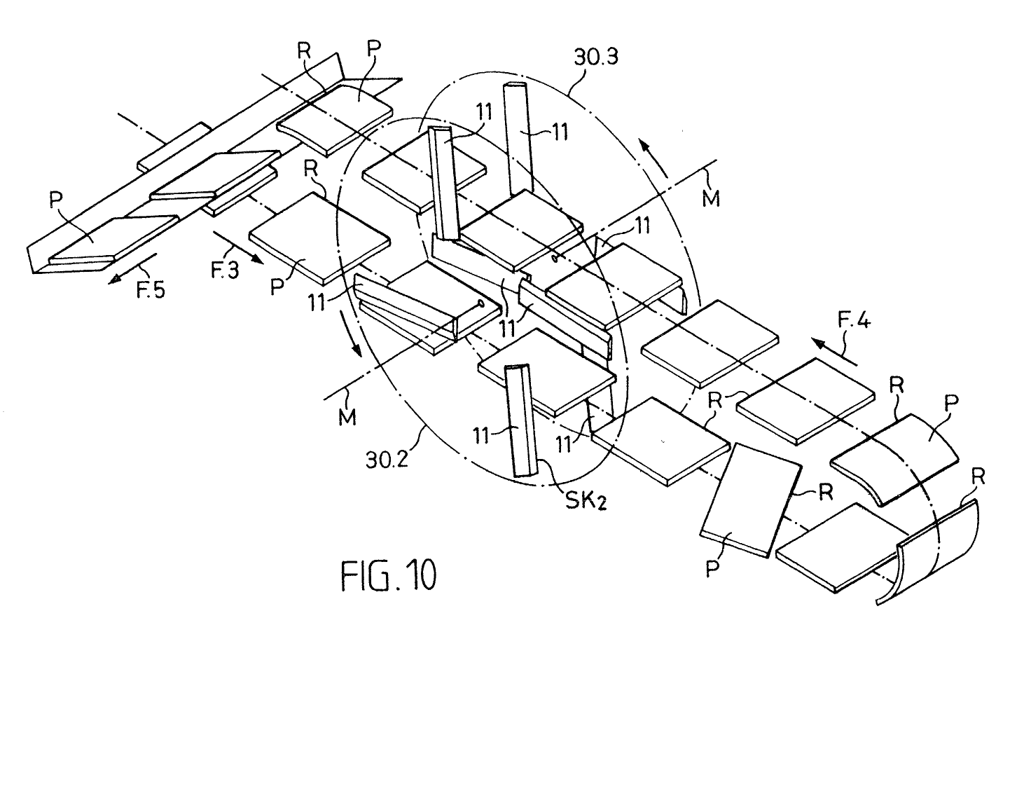

FIG. 10 shows a further arrangement for three-sided trimming of printed products e.g. magazines;

FIG. 1 shows a simple diagram for illustrating a preferred embodiment of the inventive method. The Figure shows a line F with an arrow representing the conveying direction of the objects to be cut of which one is shown and denominated G. The line F simultaneously represents a section through the support or conveying surface and a first cutting edge SKI positioned in the plane of the support surface and in parallel to the conveying direction. The Figure further shows a second cutting edge SK₂ swivelable or rotatable around a stationary rotation axis M and in a plane perpendicular to the rotation axis M with a constant rotation speed ω.

During rotation of the second cutting edge SK₂ from a first rotation position (SK₂ in unbroken lines) to a second rotation position (SK₂′ in broken lines), the second cutting edge crosses the first cutting edge, i.e. is in cutting operation together with the first cutting edge. In this kind of swiveling or rotation movement the point S₁ of the cutting edge SK₂ gets first involved in the cutting operation, i.e. represents the cutting point. Then the cutting point moves towards the left on both cutting edges. The cutting operation ends when the second cutting edge reaches the position SK₂′ and when point S₂ (position S₂′) is the cutting point on the second cutting edge.

It can easily be shown in this kind of arrangement that the speed component v_{F} in conveying direction of the cutting point on the second cutting edge SK₂ is of the same size in every moment of the cutting process and that the size of this speed component VF is directly proportional to the product of the rotation speed ω and the distance y between the support surface or the first cutting edge SK₁ and the rotation axis M.

For point S₂ of the second cutting edge SK₂, when it is in the position SK₂′ (S₂′ is the cutting point of the second cutting edge SK₂ in this position), the following is valid:

tangential speed: vₜ=2πr₂·ω,

speed component in conveying direction v_{F}=vₜ·sinα2πr₂·y/r₂=2 π·ω.

The speed component v_{F} in conveying direction is thus independent of the radius with which the cutting point moves about the rotation axis, i.e. it is constant during the whole cutting process as long as w is constant. Furthermore, it is the same as the tangential speed of a point rotating at an angle speed ω and with a radius y about M.

From this it can be followed that the local speed component in conveying direction F of the second cutting edge SK₂ can for the cutting point be made the same as the conveying speed v_{G}, by choosing y and/or ω such that the following condition is fulfilled:

y·ω=v_{G}/2π

On cutting between the two cutting edges SK₁ and SK₂ an object being conveyed continuously in the conveying direction F at a constant conveying speed v_{G} and with v_{G}=v_{F} valid for the cutting point on the second cutting edge SK₂, there is in no moment of the cutting process a relative movement in conveying direction between the object and the second cutting edge SK₂. This is theoretically only correct if the object has no extension in the direction of y, i.e. if it has no thickness. It is approximately correct if the thickness of the object to be cut is small compared to the distance y.

Between two successive cutting processes, the cutting edge SK₂ must be brought back from its rotation position after cutting (SK₂′) into the initial position (SK₂). This can either be achieved by swiveling it in the opposite direction or by further rotation around the rotation axis M in the same direction. As it follows from the above explanations that the rotation speed ω for the cutting process must be constant, rotation of the second cutting edge is more advantageous as a constant angle speed is more easily achieved for a rotation than it is achieved for an alternating swivelling movement in opposite directions.

As will be shown further on, it is advantageous to arrange a plurality of identical second cutting edges rotating about the rotation axis M.

A cutting process according to FIG. 1 begins on the downstream edge of the object G and ends on its upstream edge. Theoretically, an object G can be cut apart in one single cutting process if its extension in conveying direction is not larger than the distance between the points S₁ and S₂′ plus the distance by which the object travels during the cutting process. The second cutting edge is advantageously designed such that its beginning and its end region are not used for cutting an object, i.e. that advantageously the distance S₁-S₂′ is designed such that it is rather larger than the extension in conveying direction of the object to be cut.

From FIG. 1 it can be seen that the cutting angle (angle between the two cutting edges involved in the cutting process) decreases during the cutting process, whereby the cutting speed decreases with rising initial cutting angle β. From the above derivation if follows that the cutting angle β has no influence on the speed component v_{F}, i.e. that it can be chosen freely according to demands by the object of the invention. This is made yet clearer by FIGS. 2 to 5 in which arrangements are shown which correspond to the arrangement according to FIG. 1 excepting the initial cutting angle (β.1 to β.4). In each of the FIGS. 2 to 5 the rotation position of the second cutting edge SK₂ at the beginning of the cutting process and SK₂′ at the end of the cutting process are shown.

FIG. 2 shows a larger initial cutting angle β.1 than the initial cutting angle β in FIG. 1. Because the initial cutting angle β.1 opens away from the rotation axis as in FIG. 1 the object is cut beginning at its downstream edge, as in FIG. 1. Because the angle β.1 is larger than β (FIG. 1) the cutting speed is smaller.

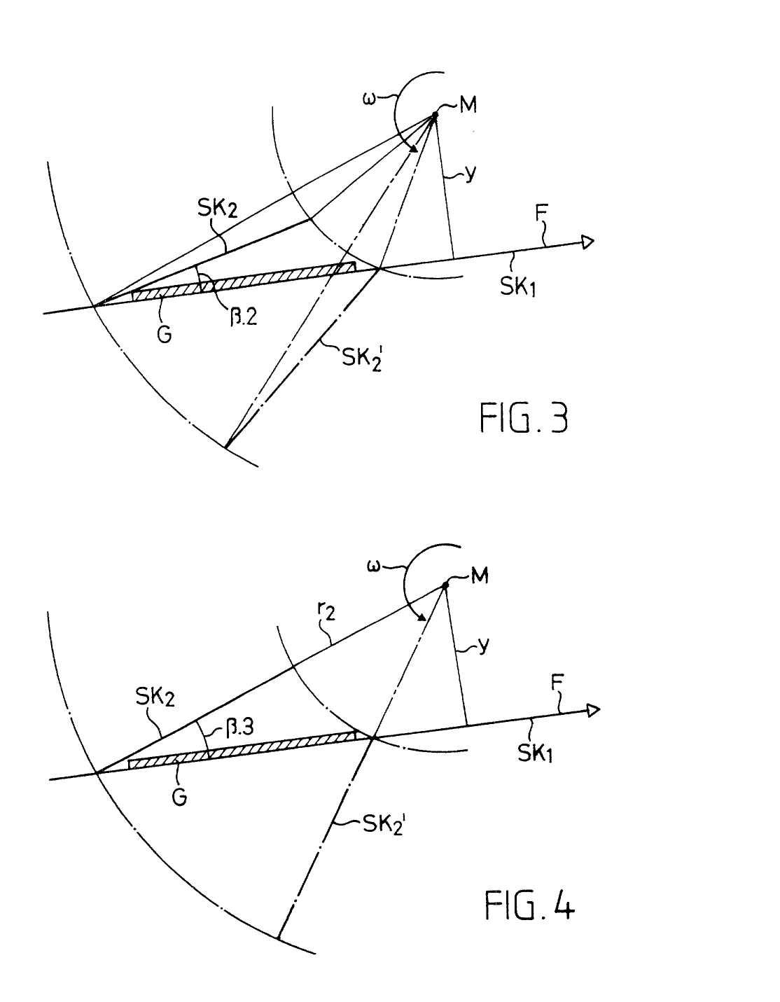

FIG. 3 shows an initial cutting angle β.2 which opens towards the rotation axis M and causes the cutting process to begin at the upstream edge of the object G. The speed conditions are identical to the ones in FIGS. 1 and 2.

FIG. 4 shows, as a special case, a second cutting edge SK₂ which is arranged radially in relation to the rotation axis M. The initial cutting angle β.3 opens, in this case also, towards the rotation axis M (the cutting process begins at the upstream edge of the object G) and is identical to the angle having a sine=y/r₂.

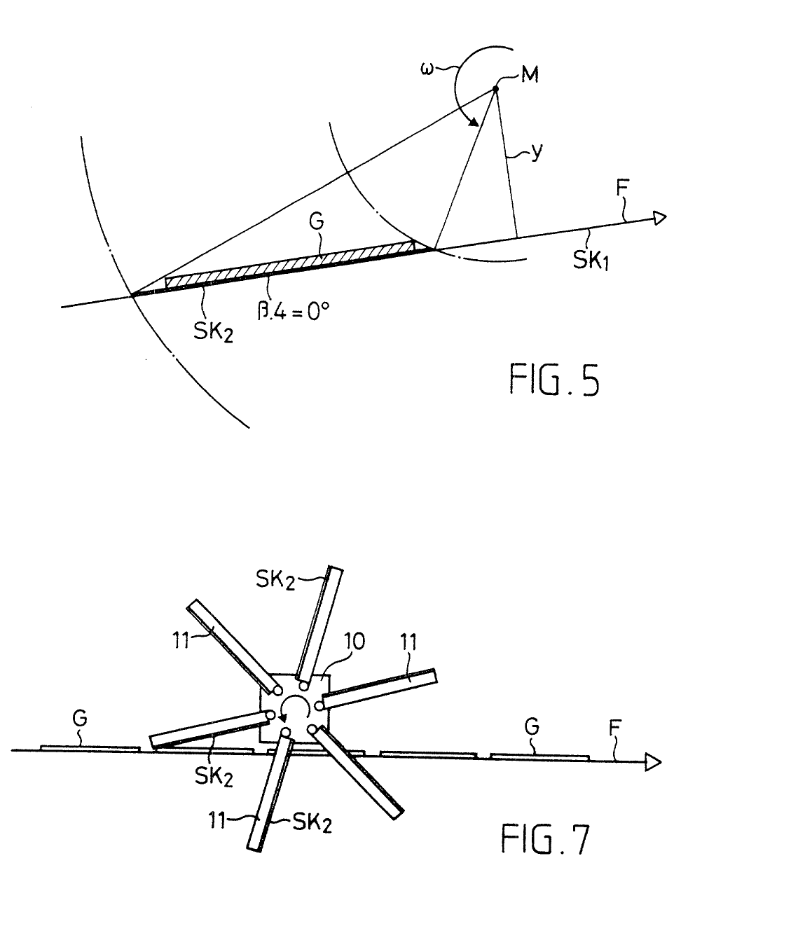

FIG. 5 shows, as an extreme case, an initial cutting angle β.4=0°, i.e. the case which is no longer a cross cut but is a full-edge-cut. The time which is necessary for this kind of cut is theoretically zero and practically only dependent on the thickness (extension in direction y) of the object G. In this kind of arrangement the condition of restriction of the relative speed to a component perpendicular to the main surfaces of an object G to be cut is still fulfilled with corresponding matching of rotation speed ω and distance y.

FIG. 6 shows an exemplified embodiment of the inventive device with a carrier 10 on which several blades 11 are arranged in star-shaped manner. The blades have second cutting edges SK₂ and the carrier is driven to rotate at a constant angle speed ω about a rotation axis M arranged at a distance y above the support surface of the objects G to be cut or above the first cutting edge SK₁ respectively.

If objects G with an extension 1 in conveying direction and distances x between each other (distances d between downstream edges=1+x) are conveyed along the support surface in conveying direction F at a constant conveying speed v_{G}, the blades 11 are to be arranged such that the distance S₁-S₂′ is at least as large as 1 minus the distance by which an object is transported forwards during a cutting process (for short cutting times at least as large as 1). If n (e.g. three) second cutting edges are provided the blades 11 must each be arranged with a displacement of 360°/n (e.g. 120°) around the center of the carrier 10. In order for one object to be cut with each cutting edge SK₂ the rotation speed o of the carrier must be adjusted such that in the same time in which the carrier rotates by360°/n (e.g. 120°) the objects are moved forwards by a distance d. Thus it can be said for ω and y:

ω=v_{G}/dn and y=dn/2π

In order for an object not to be transported into the cutting region of the two cutting edges SK₁ and SK₂ during the cutting of the preceeding object it must be seen to that, by means of corresponding choice of the cutting angle β that the cutting time is not larger than x/v_{G} (time in which an object is moved forward by the distance x). For preventing the upstream edge of an object from being cut with the outermost region of the cutting edge SK₂ (point S₂ or S₂′ respectively) the size of x must be corrected correspondingly.

FIG. 7 shows, in a very diagrammatic manner, an exemplified embodiment of the inventive device with a rotating carrier 10 on which six blades 11 are arranged in star-shaped manner such that the objects G supplied in conveying direction F are cut starting from their upstream edges, as has previously been described in connection with FIGS. 3 and 4.

The FIGS. 6 and 7 show star-shaped carriers with three or six blades 11 with cutting edges SK₂. The number of blades 11 is to be matched to the blade arrangement (cutting angle) and to a simply realizable rotation speed range. As mentioned above in connection with FIG. 1, it is also possible to arrange only one blade with a second cutting edge on a corresponding rotating carrier.

As mentioned above, it may be advantageous for specific applications to also minimize a relative movement in conveying direction between the object to be cut and the first cutting edge arranged in the plane of the support surface of the objects to be cut. FIG. 8 shows two embodiments of inventive devices which are designed in this manner.

FIG. 8 shows, again by means of an arrowed line F, a conveying direction for objects G to be cut. The cutting region is shown diagrammatically by the rotation axis M and a rotatable second cutting edge SK₂.

Regarding the device, the arrow F e.g. represents a pair of conveying belts which are arranged in parallel and at a distance to each other and are driven in synchronism in the indicated direction. Between the conveying belts indicated by arrow F break cams 15 are moved. These break cams 15 are e.g. arranged on an endless chain 17 running over two deflection pulleys 16 and are moved such that they protrude over the support surface of the objects in the cutting region and move slightly slower in conveying direction than the pair of conveying belts. By means of these break cams, the objects supplied on the conveying belts are slightly decelerated and are precisely clocked before they reach the cutting region.

E.g. on the same chain 17 there are arranged a plurality of blades 18 with first cutting edges SK₁. These blades are e.g. arranged on the chain in a pivotable manner and at a distance to the break cams such that they are positionable laterally distanced from the conveying belts. A template 19 guides the blades 18 at least in the cutting region such that the first cutting edges SK₁ are positioned in the plane of the conveying belts (support surface for the objects to be cut). First cutting edges SK₁ arranged and moved in this manner have the same speed in conveying direction as the break cams, i.e. also the same speed as the objects to be cut.

Instead of break cams acting on the downstream edges of the products to be cut as shown in FIG. 8, acceleration cams acting on the upstream edges of the objects to be cut may be provided in an analogue manner and with the same function.

In an identical or similar manner in which, according to FIG. 8 blade 18 with the first cutting edge SK₁ is moved together with the break cams 15 or the objects to be cut respectively, a whole scissors-shaped cutting device comprising two blades with first and second cutting edges pivotable in opposite direction around a rotation axis, can also be moved together with the objects to be cut. In order to fulfil the given condition regarding the relative speed of the second cutting edge to be restricted to a component perpendicular to the support surface, the rotation axis must be arranged in the plane of the support surface.

FIG. 9 shows, viewed from above, an arrangement with three inventive devices 30.1 to 30.3 for three-side trimming of printed products P with an e.g. bound, stitched or glued spine R. The printed products are conveyed in succession in a first conveying direction F.1 parallel to their spines R and their front edge opposite the spines R are trimmed with the help of the first cutting device 30.1. Then the printed products are deflected in a known manner without changing their spatial position such that they are conveyed further in a conveying direction F.2 perpendicular to their spines R. During this conveyance the top and bottom edges of the printed products are trimmed simultaneously by means of the cutting devices 30.2 and 30.3 arranged opposite to each other.

FIG. 10 shows, in a diagrammatic, three-dimensional representation, a further arrangement with which three edges of printed products P with spines R, e.g. magazines, are trimmed simultaneously by means of two simultaneously driven inventive devices 30.2 and 30.3 arranged opposite each other and in coaxial manner.

The two cutting devices 30.2 and 30.3 comprise each e.g. four blades 11 with second cutting edges SK₂ rotating about a rotation axis M.

The products P are conveyed in a supply direction F.3 to a position between the two devices 30.2 and 30.3, whereby the spines R of the products P are orientated parallel to the supply direction F.3. When passing between the two cutting devices the product edge parallel to the spine R is trimmed by one (30.2) of the cutting devices.

Then the products are rotated by 90° around their own axis such that the spine is perpendicular to the supply direction F.3 and the product stream is, by means of being deflected by 180°, turned back towards the devices 30.2 and 30.3 such that the products are conveyed, in a further conveying direction F.4, back between the two devices 30.2 and 30.3 e.g. with their spines orientated downstream. During this second passage between the devices 30.2 and 30.3 the two product edges perpendicular to the spine R are simultaneously trimmed by the two devices 30.2 and 30.3.

After the three-side trimming, the products, e.g. without changing their spatial position, are deflected by 90° and are conveyed away in a conveying-away direction F.5.

During their second passage through the double cutting device (30.2 and 30.3) the cutting arrangement is orientated the other way round in relation to gravity than in all previously described variants. This means that the first cutting edge (not shown in FIG. 10) is not arranged below the products P (in the plane of the support surface of the products) but above the products and that the second cutting edges SK₁ are not moved downwards in the cutting operation but upwards.

It is obvious that for this kind of arrangement, means must be provided for the products to be kept positioned against the first cutting edges, which function is taken over by gravity in the previously described embodiments.

In the arrangement shown in FIG. 10 it is e.g. imaginable to convey the products clamped between two belts, whereby for the first passage an outer belt and for the second passage an inner belt constitutes the support surface and whereby the first cutting edge is arranged in the region of the outer belt in both cases.

Inventive cutting devices are not only, as shown in FIGS. 9 and 10, applicable for trimming printed products but also for cutting printed products or other flat objects into two parts.

The inventive cutting method and the inventive device are not only applicable for cutting of individual objects which are conveyed in succession and at a distance from each other. They are also applicable for cutting lengthwise or for trimming lateral edges of scaled formations consisting of flat items conveyed in an overlapping manner or of quasi endless, continuously conveyed webs of material. For such applications, the condition for the distance x between the objects to be cut is not valid and the condition for the rotation speed ω is the following: n cutting lengths (S₁-S₂′, FIG. 1) cannot be smaller than the travel of the material during one rotation of the carrier carrying a star-like arrangement of n blades with second cutting edges.

1. Method for cutting flat objects (G) being continuously conveyed in a conveying direction (F) substantially parallel to the main surfaces of the objects and at a constant conveying speed (V_{G}), in which method the objects (G) are cut along a predetermined cutting line parallel to the conveying direction between a first and a second cutting edge (SK₁ and SK₂), whereby the first cutting edge (SK₁) is positioned in a plane of a surface against which the objects (G) to be cut lie with one of their main surfaces, and whereby the cutting edges (SK1 and SK₂) for the cutting process are moved past each other such that they cross each other in a cutting point and such that the cutting point moves along a predetermined cutting line across the main surfaces of the object to be cut, characterized in that at least the second cutting edge (SK₂) is moved such that during the whole cutting process at least the one point of the second cutting edge (SK₂) constituting the cutting point has a speed with a speed component perpendicular to the support surface and a speed component (v_{F}) in conveying direction (F), whereby the speed component (v_{F}) in conveying direction is of the same size as the constant conveying speed (v_{G}).

2. Method according to claim 1, characterized in that the first cutting edge (SK₁) is also moved with a speed having a speed component in conveying direction (F) of the same size as the constant conveying speed (v_{G}).

3. Method according to claim 1 or 2, characterized in that, for the cutting process, the second cutting edge (SK₂) is swiveled at a constant rotation speed about a stationary rotation axis (M) arranged opposite the surface against which the object to be cut lies, whereby the rotation speed ω and the distance (y) between said surface and the rotation axis (M) are matched such that the speed component (v_{F}) in conveying direction (F) of a point on the second cutting edge (SK₂) constituting the cutting point is of the same size as the conveying speed (v_{G}) at any moment of the cutting process.

4. Method according to claim 3, characterized in that between two successive cutting operations, the second cutting edge (SK₂) is swiveled backwards or is rotated forwards about said rotation axis (M).

5. Method according to claim 3, characterized in that a number (n) of second cutting edges (SK₂) are arranged in a plane perpendicular to the rotation axis (M) and at regular angular distances around said axis and that the arrangement of second cutting edges (SK₂) is rotated about the rotation axis such that the second cutting edges (SK₂) move past the first cutting edge (SK₁) in succession for successive cutting processes.

6. Method according to one of claims 3 to 5, characterized in that, during the cutting process, the first and second cutting edge (SK₁ and SK₂) form a cutting angle (β, β.1) opening away from the rotation axis (M) such that the cutting process begins at the downstream edge of the object (G).

7. Method according to one of claims 3 to 5, characterized in that, during the cutting process, the first and second cutting edge (SK₁ and SK₂) form a cutting angle (β, β.3) opening towards the rotation axis (M) such that the cutting process begins at the upstream edge of the object (G).

8. Method according to one of claims 1 to 7, characterized in that, prior to the cutting process, the objects to be cut (G) are decelerated or accelerated respectively by means of break cams or accelerating cams respectively.

9. Device for carrying out the method according to claim 3 for cutting objects (G) being conveyed continuously in a conveying direction (F) substantially parallel to their main surfaces and at a constant conveying speed (v_{G}) and being cut along predetermined cutting lines parallel to the conveying direction (F), which device comprises a first cutting edge (SK₁) arranged in the plane of a surface against which the objects (G) to be cut lie and in parallel to the conveying direction (F) and a second cutting edge (SK₂) moveable past the first cutting edge (SKI) in a cutting process, characterized in that a blade (11) carrying the second cutting edge (SK₂) is swivelable or rotatable at a constant rotation speed (ω) about a rotation axis (M) being arranged opposite said plane, the rotation axis (M) being arranged at a distance (y) from said plane and that the distance (y) and the rotation speed (ω) are matched to each other such that they fulfill the condition 2πy·ω=v_{G}.

10. Device according to claim 9, characterized in that a plurality of blades (11) with second cutting edges (SK₂) are arranged on a carrier (10) in a star-shaped arrangement in a plane perpendicular to the rotation axis (M), whereby the carrier (10) is functionally connected to a drive in such a manner that it is rotatable around the rotation axis at a rotation speed ω.

11. Device according to claim 9 or 10, characterized in that a blade (18) carrying the first cutting edge (SK₁) is arranged in conveying direction (F) and is movable at the conveying speed (v_{G}).
